(19) United States
(12) Patent Application Publication
(10) Pub. No.: US 2026/0370932 A1
(43) Pub. Date: Nov. 19, 2026

(54) CONTROL APPARATUS, CONTROL METHOD, AND STORAGE MEDIUM

(71) Applicant: CANON KABUSHIKI KAISHA, Tokyo (JP)

(72) Inventor: KOTARO NISHIGUCHI, Kanagawa (JP)

(21) Appl. No.: 19/564,526

(22) Filed: Mar. 12, 2026

(30) Foreign Application Priority Data
May 15, 2025 (JP) 2025-081925

(51) Int. Cl. H04N 23/63; H04N 23/661; H04N 23/695

(52) U.S. Cl. CPC H04N 23/632; H04N 23/661; H04N 23/695

(57) ABSTRACT

A control apparatus acquires an angle corresponding to an image capturing direction of an image capturing device, acquires a drive speed of the image capturing device in the image capturing direction, and causes, based on the angle, the drive speed, and a reference angle, display information related to a drive end of the image capturing device in the image capturing direction to be superimposed on an image captured by the image capturing device, and displayed.

### BACKGROUND

### Field of the Technology

The present disclosure relates to a control apparatus for controlling an image capturing unit, a control method, and a storage medium.

### Description of the Related Art

In recent years, pan-tilt zoom cameras (hereinafter also referred to as PTZ cameras) that can drive an image capturing unit of a camera in a pan direction and in a tilt direction are used at video production sites. When photographing, an external control apparatus called a controller is connected to a PTZ camera, and pan, tilt, and zoom operations of the PTZ camera are performed by using a lever and buttons that are provided on the controller, and a photographing direction of the camera and an angle of view of the camera are changed, and a subject is photographed.

In addition, cameras that support an on-screen display (hereinafter also referred to as OSD) function that displays settings and states of the camera by superimposing the settings and the states on a captured video are also used. The OSD function superimposes information of the settings of the camera and the states of the camera on video that is displayed on a display apparatus and the like from a video output terminal such as HDMI (registered trademark, High-Definition Multimedia Interface), SDI (Serial Digital Interface), and the like for the purpose of assisting camera operation by a user, mainly during image capturing.

In Japanese Patent Application Laid-Open No. 2020-122883, technology for preventing deterioration of video quality near a pan-tilt drive end by changing a cutout position in an imaging element near the drive end is disclosed. In Japanese Patent No. 3621003, technology for presenting current pan-tilt information to a user by character display and by direction display according to a pan angle and according to a tilt angle of a surveillance camera is proposed.

However, an effective method of presenting information with respect to pan and tilt (hereinafter also referred to as pan-tilt information) on an OSD is not disclosed in either Japanese Patent Application Laid-Open No. 2020-122883 or Japanese Patent No. 3621003. In a case in which presentation of pan-tilt information to a user is insufficient, for example, when the image capturing unit arrives at a limit of a movable range (drive end) at a timing not intended by the user during pan or tilt driving, the driving suddenly stops, and there is a possibility that video quality deteriorates.

### SUMMARY

According to an aspect of the present disclosure, a control apparatus acquires an angle corresponding to an image capturing direction of an image capturing device, acquires a drive speed of the image capturing device in the image capturing direction, and causes, based on the angle, the drive speed, and a reference angle, display information related to a drive end of the image capturing device in the image capturing direction to be superimposed on an image captured by the image capturing device, and displayed.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram according to a first embodiment.

FIG. 2 is a functional block diagram of an image capturing system according to the first embodiment.

FIG. 3 is a diagram showing display of captured video on which a warning display is superimposed.

FIG. 4 is a diagram showing a pan operation range and a warning start reference angle.

FIG. 5 is a diagram showing the pan operation range and a warning start angle.

FIG. 6 is a flowchart of overall processing of the image capturing system according to the first embodiment.

FIG. 7 is a flowchart of overall processing of an image capturing system according to a second embodiment.

### DESCRIPTION OF THE EMBODIMENTS

### First Embodiment

Hereinafter, embodiments will be explained by using drawings. It should be noted that content described in the embodiment is merely an example, and the present disclosure is not limited thereto.

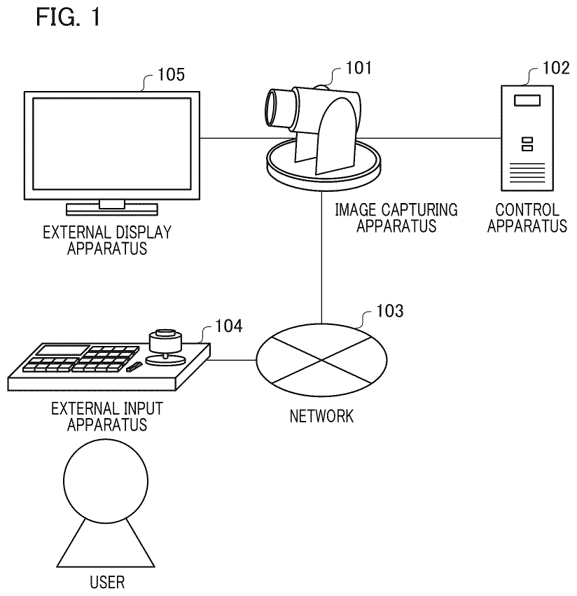

With reference to FIGS. 1 to 6, the First Embodiment will be explained. FIG. 1 shows an operation configuration example of an image capturing system that has an image capturing apparatus and a control apparatus according to the present embodiment. The image capturing system in the present embodiment has an image capturing apparatus 101 and a control apparatus 102. The image capturing apparatus 101 has a drive shaft that rotates in a pan direction and in a tilt direction, and has a zoom function capable of zooming in and zooming out. The control apparatus 102 determines whether or not to display a warning with respect to pan or tilt, and controls the warning display.

In addition, the image capturing apparatus 101 is connected to an external input apparatus 104 via a network 103, and it is possible for the image capturing apparatus 101 to receive pan, tilt, and zoom control signals from operations by a user. In addition, the image capturing apparatus 101 outputs video from a terminal compliant with standards such as SDI, HDMI, and the like, and it is possible to display the video on an external display apparatus 105.

The external input apparatus 104 is provided with a lever, buttons, and the like, and operations of pan, tilt, and zoom of the image capturing apparatus 101 are input by the user. Operations by the user are output to the image capturing apparatus 101 as the control signals of pan, tilt, and zoom described above. The external display apparatus 105 includes, for example, a liquid crystal display and the like, and displays the video captured by the image capturing apparatus 101.

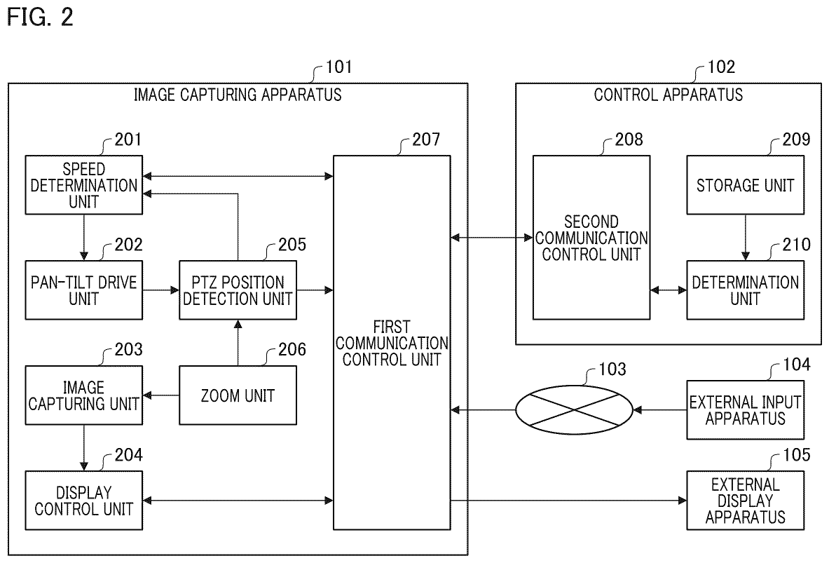

FIG. 2 is a functional block diagram of the image capturing system shown in FIG. 1. First, functions of the image capturing apparatus 101 will be described together with the configuration. The image capturing apparatus 101 is provided with a speed determination unit 201, a pan-tilt drive unit 202, an image capturing unit 203, a display control unit 204, a PTZ position detection unit 205, a zoom unit 206, and a first communication control unit 207.

The speed determination unit 201 determines a pan-tilt drive speed based on pan, tilt, and zoom control signals that are input from the external input apparatus 104 and received by the first communication control unit 207, and a focal length detected by the PTZ position detection unit 205, and transmits the pan-tilt drive speed to the pan-tilt drive unit 202. The pan-tilt drive speed is a speed at which the image capturing apparatus 101 rotates in a pan direction or in a tilt direction. In the present embodiment, based on a current focal length and pan, tilt, and zoom control signals that are input from the external input apparatus 104 based on a user operation, from among the control signals, the pan drive speed is determined based on the pan control signal, and the tilt drive speed is determined based on the tilt control signal. A detailed calculation method of the pan drive speed and the tilt drive speed will be described below. That is, the speed determination unit 201 functions as an acquisition unit that acquires a drive speed in an image capturing direction of the image capturing unit.

The pan-tilt drive unit 202 rotationally drives the image capturing unit 203 of the image capturing apparatus 101 by a motor in a pan direction and/or in a tilt direction, the pan direction and/or the tilt direction being the image capturing direction, and changes an image capturing angle of view. It should be noted that pan-tilt driving denotes driving in the pan direction and/or in the tilt direction. The image capturing unit 203 has a lens, an image capturing element, a development processing unit, and the like, captures an image of a subject, and performs processing for converting the captured video to an electrical signal. In addition, noise removal processing and the like may be performed in the development processing unit.

The display control unit 204 receives a determination result obtained by a determination unit 210 of the control apparatus 102 via a second communication control unit 208 and the first communication control unit 207, and superimposes OSD information on the captured video acquired by the image capturing unit 203 according to the result. Then, the video is displayed on the external display apparatus 105 via the first communication control unit 207. That is, the display control unit 204 functions as a control unit that superimposes display information with respect to a drive end in the image capturing direction on an image captured by the image capturing unit and causes the image to be displayed, based on the angle in the image capturing direction, the drive speed, and the reference angle.

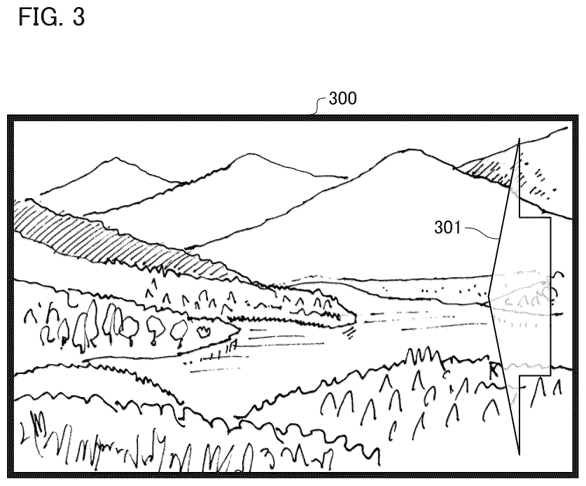

An example of video output to the external display apparatus 105 in the present embodiment is shown in FIG. 3. FIG. 3 is an example of video output on the external display apparatus 105 when the pan-tilt drive unit 202 rotates the image capturing apparatus 101 around a pan drive shaft clockwise as viewed from above (pan driving), and the image capturing apparatus 101 approaches the drive end. A drive end approach warning display 301 superimposed on a video 300 indicates that the drive end on the right side with respect to the image capturing angle of view is approaching. That is, the drive end approach warning display 301 is superimposed on the video 300 as OSD information. It should be noted that “warning” in the following explanation refers to a warning of approach to the drive end of pan or of tilt.

The PTZ position detection unit 205 detects a current pan angle of the pan-tilt drive unit 202 and a current tilt angle of the pan-tilt drive unit 202 for use in determination by the determination unit 210 as to whether or not to output the warning display, and transmits the current pan angle and the current tilt angle to the control apparatus 102 via the first communication control unit 207. In addition, the PTZ position detection unit 205 detects a focal length of the zoom unit 206 for use in determination of the pan-tilt drive speed, and transmits the focal length to the speed determination unit 201. That is, the PTZ position detection unit 205 functions as a detection unit that detects an angle in the image capturing direction of the image capturing unit. In addition, the PTZ position detection unit 205 detects the focal length in the zoom function.

The zoom unit 206 controls the image capturing angle of view of the image capturing unit 203 by changing the focal length. That is, the zoom unit 206 corresponds to a zoom function for enlarging or reducing an image capturing region.

The first communication control unit 207 transmits the pan-tilt drive speed determined by the speed determination unit 201, and the pan angle and the tilt angle detected by the PTZ position detection unit 205 to the second communication control unit 208. In addition, the first communication control unit 207 transmits pan, tilt, and zoom control signals input from the external input apparatus 104 via the network 103 to the speed determination unit 201. Furthermore, the first communication control unit 207 transmits a video signal generated by the display control unit 204 to the external display apparatus 105.

Next, the control apparatus 102 will be explained. The control apparatus 102 is provided with the second communication control unit 208, a storage unit 209, and the determination unit 210.

The second communication control unit 208 receives, via the first communication control unit 207, the pan-tilt drive speed determined by the speed determination unit 201 and the pan angle and the tilt angle detected by the PTZ position detection unit 205. In addition, the second communication control unit 208 transmits the determination result determined by the determination unit 210 as to whether or not to display a warning to the first communication control unit 207.

The storage unit 209 stores (holds) a standard drive speed preset by the user and a warning start reference angle preset by the user. The warning start reference angle is an angle serving as a reference for the warning of approach to the drive end of pan or of tilt described above, and the warning start reference angle is set for pan and for tilt.

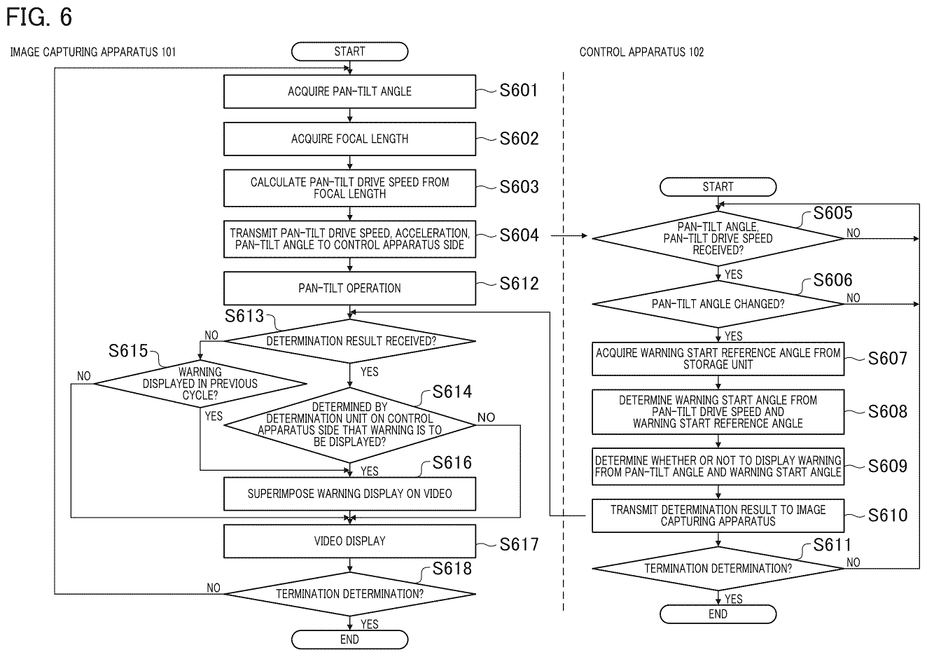

The determination unit 210 determines whether or not to output a warning of approach to the drive end of pan or of tilt based on the pan-tilt drive speed received via the second communication control unit 208, the pan angle and the tilt angle, and the standard drive speed and the warning start reference angle held in the storage unit 209. The determination method of the determination unit 210 will be described in detail in the explanation of FIG. 6. That is, the determination unit 210 determines whether to display a warning with respect to the drive end in the pan direction or in the tilt direction, based on the angle detected by the position detection unit, the drive speed acquired by the acquisition unit, and the predetermined warning start reference angle.

It should be noted that a connection method for the external display apparatus 105 may be a form included within the apparatus such as PCIe (registered trademark, Peripheral Component Interconnect-Express), and the like, or an existing video output standard such as SDI, HDMI, and the like may be used.

In addition, although one image capturing apparatus 101 is assumed in the explanation of the present embodiment, a form that includes two or more image capturing apparatuses may be used. In addition, the image capturing apparatus 101 and the control apparatus 102 may be configured integrally. In this case, the speed determination unit 201, the display control unit 204, the PTZ position detection unit 205, the zoom unit 206, and the determination unit 210 shown in FIG. 2 configure an image capturing control apparatus that controls driving of the image capturing unit in the pan direction.

In addition, in the present embodiment, although communication between the image capturing apparatus 101 and the control apparatus 102 is assumed to be performed via a network, the communication method is not limited, and for example, communication may be performed by serial communication and the like. In addition, although an Internet line is assumed for the network 103 in the present embodiment, the network 103 may be a LAN or other proprietary networks.

### (Pan-Tilt Drive End Approach Warning Display)

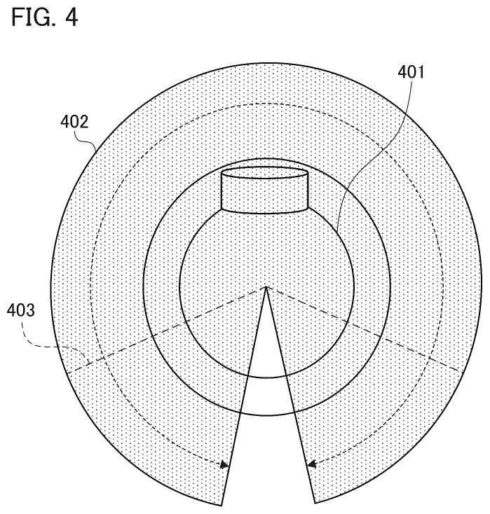

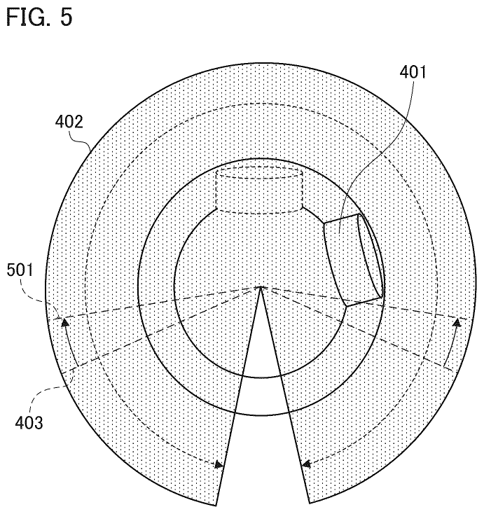

Hereinafter, determination processing of pan-tilt warning display in the present embodiment will be explained by using FIG. 4, FIG. 5, and FIG. 6. In the present embodiment, an example of a reference angle for warning a user of approach to a pan drive end (drive limit) in the determination unit 210 of the control apparatus 102 is illustrated in FIG. 4. In FIG. 4, reference numeral 401 denotes an outer appearance of a lens barrel unit of the image capturing apparatus 101 as viewed from above the body, and a range 402 that is a grayed-out portion is a range in which the image capturing apparatus 101 can be rotationally driven around a pan drive shaft. A broken line 403 indicates the warning start reference angle held in the storage unit 209 of the control apparatus 102. FIG. 5 is a diagram showing that the warning start angle is changed from the warning start reference angle in order to make the warning start earlier than in the case shown in FIG. 4. Details of FIG. 5 will be described below. In the present embodiment, display information is displayed in a case in which the pan angle exceeds the warning start angle (warning start reference angle). Accordingly, the warning start angle corresponds to a display start angle.

FIG. 6 is a flowchart of processing (control method) for determining whether or not to display a warning of approach to a pan drive end or a tilt drive end and for performing an output to the external display apparatus 105 according to the present embodiment. In FIG. 6, the image capturing apparatus 101 that performs mainly image capturing, pan-tilt driving, and video display processing, and processing of the control apparatus 102 that determines whether or not a drive end approach warning should be displayed in a case in which pan-tilt driving has occurred, are shown separately. In FIG. 6, the processing of the image capturing apparatus 101 is performed in a cycle in which captured video is output while the camera (image capturing apparatus 101) is activated, and processing of the control apparatus 102 is started, triggered by communication from the image capturing apparatus 101.

First, in step S601 of the image capturing apparatus 101 in FIG. 6, the PTZ position detection unit 205 acquires an angle in the pan direction of the pan-tilt drive unit 202 and an angle in the tilt direction of the pan-tilt drive unit 202 (pan angle, tilt angle) (hereinafter, a set of the pan angle and the tilt angle is collectively denoted as a pan-tilt angle).

In step S602, the PTZ position detection unit 205 detects and acquires a focal length of the zoom unit 206. Next, in step S603, the speed determination unit 201 calculates the drive speed in the pan direction and the drive speed in the tilt direction (pan-tilt drive speed) based on the current focal length and input of pan-tilt driving (operation signal) from the external input apparatus 104. That is, the speed determination unit 201 calculates the drive speeds based on the focal length and an operation signal for changing an angle in the pan direction and an angle in the tilt direction.

The external input apparatus 104 can input a pan-tilt drive input value that specifies a drive direction and a drive speed for each of the pan direction and the tilt direction. As for the method for calculating (determining) the pan-tilt drive speed in the speed determination unit 201, first, the focal length detected in step S602 is transmitted to the speed determination unit 201 and converted to an angle of view θ_{view} [deg]. In addition, an angle-of-view velocity magnification preset in the image capturing apparatus 101 is denoted as r_{view}. Additionally, input values from the external input apparatus 104 received via the first communication control unit 207 and converted such that a maximum input value thereof is 100 and a state in which input is not performed is 0, are denoted as a pan-tilt drive input value r_{pan input} and a pan-tilt drive input value Stilt input. Then, by using the angle of view θ_{view}, the angle-of-view velocity magnification r_{view}, the pan-tilt drive input value r_{pan input}, and the pan-tilt drive input value r_{tilt input}, a pan drive speed ωₚₐₙ and a tilt drive speed ωₜᵢₗₜ are calculated in the following Equation (1). Hereinafter, the pan drive speed ωₚₐₙ and the tilt drive speed ωₜᵢₗₜ are also collectively denoted as the pan-tilt drive speed.

$$\{ \begin{matrix}{ω}_{pan} = {θ}_{view} \times {r}_{view} \times {r}_{pan input} \\ {ω}_{tilt} = {θ}_{view} \times {r}_{view} \times {r}_{tilt input}\end{matrix} \qquad ( 1 )$$

Next, in step S604, the first communication control unit 207 transmits the current pan angle θₚₐₙ in the pan direction and the current tilt angle θₜᵢₗₜ in the tilt direction, and the pan drive speed ωₚₐₙ and the tilt drive speed ωₜᵢₗₜ, to the determination unit 210 via the second communication control unit 208.

In step S605 of the control apparatus 102 in FIG. 6, in a case in which the determination unit 210 has received data of the pan-tilt drive speed and the pan-tilt angle from the image capturing apparatus 101 in step S604, the determination unit 210 proceeds to step S606. In a case in which the data is not received, the processing waits until the data is received from the image capturing apparatus 101.

In step S606, the determination unit 210 determines whether or not the current position of pan and the current position of tilt received in step S605 are changed from the position of pan and the position of tilt in the immediately preceding cycle. In a case in which the current position of pan and the current position of tilt are not changed from the position of pan and the position of tilt in the immediately preceding cycle, the processing returns to step S605, and the processing waits until the pan-tilt drive speed and the pan-tilt angle are transmitted again from the image capturing apparatus 101. In a case in which the current position of pan and the current position of tilt are changed from the position of pan and the position of tilt in the immediately preceding cycle, the processing proceeds to step S607.

In step S607, the determination unit 210 acquires the warning start reference angle θ_{pan std} and the warning start reference angle θ_{tilt std}, and the standard drive speed ω_{pan std} and the standard drive speed ω_{tilt std} from the storage unit 209.

In step S608, the determination unit 210 uses the current pan drive speed ωₚₐₙ and the current tilt drive speed θₜᵢₗₜ, the warning start reference angle θ_{pan std} and the warning start reference angle θ_{tilt std}, and the standard drive speed ω_{pan std} and the standard drive speed ω_{tilt std}, and calculates a warning start angle.

As described above, FIG. 4 shows the outer appearance 401 of the image capturing apparatus 101, the range 402 in which the image capturing apparatus 101 can be driven in the pan direction, and the warning start reference angle 403. Assuming that the image capturing apparatus 101 is driven from the warning start reference angle 403 at the standard drive speed ω_{pan std}, the time t_{pan std} [s] until arriving at a pan drive end is determined as in the following Equation (2).

t_{pan std}=θ_{pan std}/ω_{pan std} (2)

Similarly, a time for the tilt direction is also calculated, and t_{pan std} and t_{tilt std} are held in the storage unit 209 as the reference times from warning start until arriving at the drive end. As described above, when the pan and tilt of the image capturing apparatus 101 are operated and image capturing is performed, the time from the drive end warning start until actually arriving at the drive end differs depending on the drive speed of pan or of tilt. In particular, in a case in which the drive speed is greater than the standard drive speed ω_{pan std} and the standard drive speed ω_{tilt std} assumed in advance, there is a possibility that a time from warning start until actually arriving at the drive end cannot be sufficiently secured.

Accordingly, a time t_{pan reach} and a time t_{tilt reach} to arrive at the drive end are calculated from the current pan-tilt drive speed and pan-tilt angle as shown in the following Equation (3).

$$\{ \begin{matrix}{t}_{pan reach} = {θ}_{pan} / {ω}_{pan} \\ {t}_{tilt reach} = {θ}_{tilt} / {ω}_{tilt}\end{matrix} \qquad ( 3 )$$

In a case in which the time t_{pan reach} and the time t_{tilt reach} calculated by Equation (3) are shorter than the reference time t_{pan std} and the reference time t_{tilt std} from the warning start until actually arriving at the drive end, the warning start is changed so as to occur earlier. By changing in this manner, time from the warning start until actually arriving at the drive end is ensured. FIG. 5 is a diagram showing that the warning start is changed from the warning start reference angle 403 to a warning start angle 501. That is, in a case in which the drive speed is faster than the reference speed, the warning start angle (display start angle) is made smaller than the reference angle.

The warning start angle θ_{pan expand} and the warning start angle θ_{tilt expand} at this time are as shown in the following Equation (4).

$$\{ \begin{matrix}{θ}_{pan expand} = {ω}_{pan} \times {t}_{pan std} \\ {θ}_{tilt expand} = {ω}_{tilt} \times {t}_{tilt std}\end{matrix} \qquad ( 4 )$$

From the above, the actual warning start angle θ_{pan caution} and the actual warning start angle θ_{tilt caution} are as shown in the following Equations (5) and (6). That is, the determination unit 210 calculates the display start angle based on the angle, the drive speed, and the warning start reference angle.

$${θ}_{pan caution} = \{ \begin{matrix}{θ}_{pan std} , & {t}_{pan std} > {t}_{pan reach} \\ {θ}_{pan expand} , & {t}_{pan std} \leq {t}_{pan reach}\end{matrix} \qquad ( 5 )$$

$${θ}_{tilt caution} = \{ \begin{matrix}{θ}_{tilt std} , & {t}_{tilt std} > {t}_{tilt reach} \\ {θ}_{tilt expand} , & {t}_{tilt std} \leq {t}_{tilt reach}\end{matrix} \qquad ( 6 )$$

According to Equations (5) and (6), in a case in which the time to arrive at the drive end obtained from the current pan-tilt drive speed and pan-tilt angle is equal to or less than the reference time to arrive at the drive end obtained from the standard drive speed and warning start reference angle, the warning start angle is changed so that the warning occurs earlier.

In step S609, from the current pan-tilt angle and the warning start angle θ_{pan caution} and the warning start angle θ_{tilt caution} calculated in step S608, the determination unit 210 determines whether or not a warning should be displayed. In a case in which the distance from θₚₐₙ to the drive end becomes smaller than the distance from θ_{pan caution} to the drive end or the distance from θₜᵢₗₜ to the drive end becomes smaller than and the distance from θ_{tilt caution} to the drive end, a determination is made that warning display should be performed, and in a case in which the distances are not smaller, a determination is made that warning display is unnecessary.

In step S610, the determination unit 210 transmits the determination result from step S609 to the first communication control unit 207 via the second communication control unit 208. Thereafter, in step S611, a determination is made as to whether to end the processing at the control apparatus 102. In a case in which the processing is not ended, the processing returns to step S605, and the processing waits until the pan-tilt drive speed and the pan-tilt angle from the image capturing apparatus 101 are transmitted again.

In step S612 of the image capturing apparatus 101 in FIG. 6, the speed determination unit 201 transmits the pan-tilt drive speed calculated in step S603 to the pan-tilt drive unit 202, and executes pan-tilt drive at that speed.

In step S613, the processing branches depending on whether or not the determination result from step S609 has been received. In a case in which the determination result has been received, the processing proceeds to step S614. In step S614, the processing branches depending on the determination result from step S609. In a case in which the determination result indicates that a warning should be displayed, in step S616 the display control unit 204 superimposes OSD information of the drive end approach warning in the corresponding direction of pan or of tilt on the captured video acquired by the image capturing unit 203. In contrast, in a case in which warning display was deemed unnecessary, the display control unit 204 does not superimpose OSD information on the captured video acquired by the image capturing unit 203.

In a case in which the determination result had not been received in step S613, the processing proceeds to step S615. In step S615, the processing branches depending on whether a drive end approach warning was being displayed in the immediately previous cycle. The determination result not being received in step S613 corresponds to a case in which the pan-tilt angle had not been changed in step S606. Accordingly, in a case in which a warning was being displayed in the immediately previous cycle, a determination can be made that the pan-tilt angle has not moved from that point, and the processing proceeds to step S616. Then, as described above, the display control unit 204 superimposes OSD information of the drive end approach warning in the corresponding direction of pan and/or of tilt on the captured video acquired by the image capturing unit 203.

Further, in a case in which warning display was not being performed in the immediately previous cycle in step S615, a determination can be made that the pan-tilt angle has not moved from that point, and the processing proceeds to step S617, and the display control unit 204 does not superimpose OSD information on the captured video acquired by the image capturing unit 203.

In step S617, the video generated by the display control unit 204 is output to the external display apparatus 105. Thereafter, in step S618, a determination is made as to whether to end the processing at the image capturing apparatus 101. In a case in which the processing is not ended, the processing returns to step S601, and the PTZ position detection unit 205 acquires the pan-tilt angle. In a case in which the processing is ended, a series of processing for determination and output of the drive end approach warning is ended.

According to the flowchart of FIG. 6, step S601 functions as a detection step, step S603 functions as an acquisition step, and step S616 functions as a control step.

As explained above, in the First Embodiment, a configuration was adopted in which pan drive end and tilt drive end approach warning display is performed based on the warning start reference angle set in advance or the warning start angle determined by the current pan-tilt drive speed. As a result, ensuring a time interval from when warning display is started until actually arriving at the drive end becomes possible, in consideration of the pan-tilt drive speed that changes in accordance with the focal length of the image capturing apparatus 101. Accordingly, when approaching the drive end during pan-tilt drive, the pan-tilt information can be appropriately presented to the user, and unintended abrupt stoppage can be avoided.

It should be noted that, although in the present embodiment the control apparatus 102 is implemented as an apparatus external to the image capturing apparatus 101, a configuration in which the control apparatus is an apparatus internal to the image capturing apparatus 101 or a program may be adopted.

In addition, although in the present embodiment values based on the focal length and operation input of the external input apparatus 104 are used for calculation of pan-tilt drive speed at the speed determination unit 201 as shown in Equation (1), the calculation may be performed from only values based on an operation input of the external input apparatus 104. That is, the drive speed may be calculated based on an operation signal for changing an angle in the pan direction and an angle in the tilt direction.

In addition, although in the present embodiment OSD information is superimposed on the video captured by the image capturing apparatus 101 and output to the external display apparatus 105, in addition to this output, video for recording or distribution on which OSD information is not superimposed may be output and recorded.

### Second Embodiment

Next, the Second Embodiment will be explained in detail with reference to figures. The same reference numerals are assigned to portions that are the same as configurations or operations explained in the First Embodiment, and explanation thereof is omitted. It should be noted that content described in the embodiments is exemplary, and the content described in the embodiments is not limited thereto.

In the present embodiment, a case in which drive end approach warning is displayed by using pan-tilt drive speed and acceleration (angular acceleration) in the pan direction and in the tilt direction will be explained. The following explanation will mainly explain determination processing for approach warning display using acceleration of the pan drive axis and of the tilt drive axis, the determination processing being a point of difference from the First Embodiment.

For example, there are cases in which the user performs an operation to drive while continuously changing the drive speed of pan or of tilt using a joystick or the like provided in the external input apparatus 104 while approaching the warning start angle. In this case, in a case in which the warning start angles θ_{pan caution} and θ_{tilt caution} are calculated by the calculation method shown in the First Embodiment, there are cases in which the time from the warning start until actually arriving at the drive end differs significantly.

Although, in the First Embodiment, a configuration was adopted in which the warning start angle is calculated based on the pan-tilt drive speed calculated by the speed determination unit 201, in the present embodiment, a configuration is adopted in which the warning start angle is calculated in further consideration of acceleration in the pan direction and in the tilt direction.

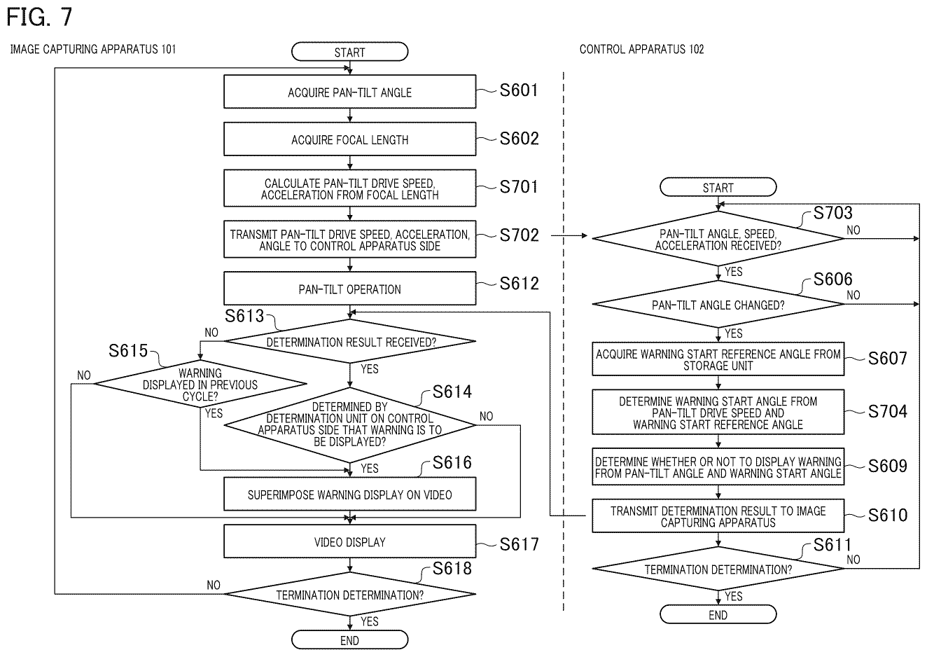

Warning start angle calculation processing using pan-tilt speed and acceleration will be explained by using FIG. 7. The same step numbers as in FIG. 6 are assigned to steps that perform processing similar to that in FIG. 6, and explanation thereof is omitted.

In steps S601 and S602, the pan-tilt angle and the focal length are acquired in the same manner as in the First Embodiment.

In subsequent step S701, the speed determination unit 201 calculates the pan-tilt drive speed in the same manner as in the First Embodiment, and then compares the pan-tilt drive speed with the pan-tilt drive speed calculated in the immediately previous cycle, and calculates a change in pan speed per unit time and a change in tilt speed per unit time. Changes in pan-tilt speed per unit time calculated here are taken as pan-tilt acceleration αₚₐₙ [deg/s²] and pan-tilt acceleration θₜᵢₗₜ [deg/s²]. That is, the speed determination unit 201 also functions as an acceleration detection unit that detects acceleration, the acceleration being an amount of movement (amount of variation) per unit time of the drive speed.

Next, in step S702, the first communication control unit 207 transmits the pan-tilt angle detected in step S601, the pan-tilt drive speed calculated in step S701, and the pan-tilt acceleration to the determination unit 210 via the second communication control unit 208.

In step S703 of the control apparatus 102 in FIG. 7, in a case in which the determination unit 210 has received the data of the pan-tilt angle, the pan-tilt drive speed, and the pan-tilt acceleration sent from the image capturing apparatus 101 in step S702, the determination unit proceeds to step S606. In a case in which the data has not been received, the determination unit waits until the data is received from the image capturing apparatus 101.

Steps S606 and S607 are the same as in the First Embodiment. In subsequent step S704, the warning start angle is calculated by using the current pan drive speed ωₚₐₙ and the current tilt drive speed ωₜᵢₗₜ, the pan acceleration θₚₐₙ and the tilt acceleration αₜᵢₗₜ, the warning start reference angle θ_{pan std} and the warning start reference angle θ_{tilt std}, and the standard drive speed ω_{pan std} and the standard drive speed ω_{tilt std}. The time t_{pan reach} accel and the time t_{tilt reach} accel to arrive at the drive end in consideration of pan-tilt acceleration can be calculated by the following Equation (7).

$$\{ \begin{matrix}{t}_{pan reach accel} = \frac{- {ω}_{pan} + \sqrt{{ω}_{pan}^{2} + 2 {α}_{pan} {θ}_{pan}}}{2 {α}_{pan}} \\ {t}_{tilt reach accel} = \frac{- {ω}_{tilt} + \sqrt{{ω}_{tilt}^{2} + 2 {α}_{tilt} {θ}_{tilt}}}{2 {α}_{tilt}}\end{matrix} \qquad ( 7 )$$

The warning start angle θ_{pan expand accel} and the warning start angle θ_{tilt expand accel} at this time are as shown in the following Equation (8).

$$\{ \begin{matrix}{θ}_{pan expand} = {ω}_{pan} \times {t}_{pan std} + \frac{{α}_{pan} {t}_{std}^{2}}{2} \\ {θ}_{tilt expand} = {ω}_{tilt} \times {t}_{tilt std} + \frac{{α}_{tilt} {t}_{std}^{2}}{2}\end{matrix} \qquad ( 8 )$$

From the above, the actual warning start angle θ_{pan caution accel} and the actual warning start angle θ_{tilt caution accel} are as shown in the following Equations (9) and (10).

$${θ}_{pan caution accel} = \{ \begin{matrix}{θ}_{pan std} , & {t}_{pan std} > {t}_{pan reach accel} \\ {θ}_{pan expand accel} , & {t}_{pan std} \leq {t}_{pan reach accel}\end{matrix} \qquad ( 9 )$$

$${θ}_{tilt caution accel} = \{ \begin{matrix}{θ}_{tilt std} , & {t}_{tilt std} > {t}_{tilt reach accel} \\ {θ}_{tilt expand accel} , & {t}_{tilt std} \leq {t}_{tilt reach accel}\end{matrix} \qquad ( 10 )$$

Next, in step S609, in the same manner as in the First Embodiment, the determination unit 210 determines whether or not warning display should be performed from the current pan-tilt angle and the warning start angle θ_{pan caution accel} and the warning start angle θ_{tilt caution accel}. In a case in which the distance from θₚₐₙ to the drive end and the distance from θₜᵢₗₜ to the drive end are smaller than the distance from θ_{pan caution accel} to the drive end and the distance from θ_{tilt caution accel} to the drive end, a determination is made that warning display should be performed, and in a case in which the distances are not smaller, a determination is made that warning display is unnecessary. Steps S610 and S611 are the same as in the First Embodiment. That is, the determination unit 210 determines whether to display a warning related to the drive end in the pan direction and in the tilt direction based on the angle, the drive speed, the reference angle, and the acceleration.

From step S609 onward, in the same manner as in the First Embodiment, superimposition of drive end warning display is performed based on the determination result transmitted from the control apparatus 102, and the video is output to the external display apparatus 105.

As explained above, in the Second Embodiment, a configuration was adopted in which the determination unit 210 calculates the warning start position in consideration of the current pan-tilt acceleration, and determines whether to perform warning display by comparing with the current pan-tilt angle. As a result, for example, in a case in which the warning display angle is approached during deceleration, it becomes possible to determine that the warning need not be output. In addition, ensuring time from the warning start until actually arriving at the drive end becomes possible.

It should be noted that, in the two embodiments explained above, warning display may be continued until driving in the pan direction or in the tilt direction stops even if the focal length is updated. For example, in cases such as when the determination unit 210 determines to display a warning when the focal length is continuously fluctuating while performing pan driving, the drive speed fluctuates due to fluctuation in the focal length. Continuing the warning display prevents the warning display from becoming unstable, such as by repeatedly alternating between display and non-display of the warning.

In addition, in the two embodiments explained above, in a case in which the user continues operation of the external input apparatus 104 in a state in which the warning is being displayed and the apparatus is driven so as to further approach the drive end, the warning content may be changed. Examples include changing the color of the drive end approach warning display 301 shown in FIG. 3 or causing the drive end approach warning display 301 to blink. A threshold for changing the warning content may be appropriately set, such as when the angle becomes an angle that is one-half of the warning start angle θ_{pan caution} and the warning start angle θ_{tilt caution} shown in Equations (5) and (6).

### OTHER EMBODIMENTS

The present disclosure can also be realized by processing in which a program that realizes one or more functions of the embodiments explained above is supplied to a system or apparatus via a network or storage medium, and one or more processors in a computer of the system or apparatus read and execute the program. Further, the present disclosure can also be realized by a circuit that realizes one or more functions (for example, an ASIC).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-081925, filed May 15, 2025, which is hereby incorporated by reference herein in its entirety.

What is claimed is:

1. A control apparatus comprising:
at least one memory storing instructions; and
at least one processor executing the stored instructions causing the control apparatus to:
acquire an angle corresponding to an image capturing direction of an image capturing device;
acquire a drive speed of the image capturing device in the image capturing direction; and
cause, based on the angle, the drive speed, and a reference angle, display information related to a drive end of the image capturing device in the image capturing direction to be superimposed on an image captured by the image capturing device, and displayed.

2. The control apparatus according to claim 1, wherein, in a case in which the angle exceeds a display start angle calculated based on the drive speed and the reference angle, the display information is displayed.

3. The control apparatus according to claim 2, wherein, in a case in which the drive speed is faster than a reference speed, the display start angle is smaller than the reference angle.

4. The control apparatus according to claim 2, wherein the display start angle is determined in accordance with the drive speed.

5. The control apparatus according to claim 1, wherein the at least one processor further executes the stored instructions causing the control apparatus to acquire a focal length of the image capturing device; and
wherein the drive speed is calculated based on the focal length.

6. The control apparatus according to claim 5, wherein, in a case in which the focal length changes, the display of the display information is continued until driving in the image capturing direction stops even if the focal length is updated.

7. The control apparatus according to claim 5, wherein the drive speed is calculated based on the focal length and an operation signal for changing an angle of the image capturing direction.

8. The control apparatus according to claim 1, wherein executing the stored instructions by the processor further causes the control apparatus to acquire an acceleration that is an amount of movement per unit time of the drive speed; and
wherein the display information is displayed based on the angle, the drive speed, the reference angle, and the acceleration in the image capturing direction.

9. The control apparatus according to claim 1, wherein the drive speed is calculated based on an operation signal for changing the angle corresponding to the image capturing direction.

10. The control apparatus according to claim 1, wherein, in a case in which the image capturing device is further driven so as to approach the drive end in a state in which the display information is being displayed, content of the display information is changed.

11. The control apparatus according to claim 1, wherein, in a case in which the image capturing device is further driven so as to approach the drive end in a state in which the display information is being displayed, the display information is displayed in a blinking manner.

12. The control apparatus according to claim 1, wherein the image capturing direction is a pan direction.

13. The control apparatus according to claim 1, wherein the image capturing direction is a tilt direction.

14. A control method comprising:
acquiring an angle corresponding to an image capturing direction of an image capturing device;
acquiring a drive speed of the image capturing device in the image capturing direction; and
causing, based on the angle, the drive speed, and a reference angle, display information related to a drive end of the image capturing device in the image capturing direction to be superimposed on an image captured by the image capturing device, and displayed.

15. A non-transitory storage medium storing a program of a control apparatus causing a computer to perform each step of a control method of the control apparatus, the method comprising:
acquiring an angle corresponding to an image capturing direction of an image capturing device;
acquiring a drive speed of the image capturing device in the image capturing direction; and
causing, based on the angle, the drive speed, and a reference angle, display information related to a drive end of the image capturing device in the image capturing direction to be superimposed on an image captured by the image capturing device, and displayed.
